(19) United States
(12) Patent Application Publication
(10) Pub. No.: US 2007/0236685 A1
(43) Pub. Date: Oct. 11, 2007

(54) Optical tilt sensor

(75) Inventor: Torsten Wipiejewski, Hong Kong (CN)

Correspondence Address: BUCHANAN, INGERSOLL & ROONEY PC, POST OFFICE BOX 1404, ALEXANDRIA, VA, 22313-1404, US

(73) Assignee: Hong Kong Applied Science and Technology Research Institute Co., Ltd., Hong Kong (CN)

(21) Appl. No.: 11/392,488

(22) Filed: Mar. 30, 2006

(51) Int. Cl. G01B 11/26; G01B 11/14; G01P 3/36

(52) U.S. Cl. 356/139.03; 356/614; 356/28

(57) ABSTRACT

An optoelectronic device comprising an optical source and an optical detector, the optical source being adapted for emitting an optical beam for subsequent reflection towards the optical detector, the optical detector being adapted for receiving the optical beam and comprises a plurality of discrete optical detection regions for converting an optical beam into electrical energy and the optical detection regions are arranged so that an electrical characteristic of the optical detector is dependent on the relative distribution of an incident optical beam on the plurality of optical detection regions.

### FIELD OF THE INVENTION

This invention relates to optoelectronic devices and, more particularly, to optoelectronic devices for monitoring tilt or displacements of an object. This invention also relates to an optoelectronic sensor for tilt, displacement or movement sensing.

### BACKGROUND OF THE INVENTION

Monitoring and/or measuring of tilt, displacement or movements of an object is important for many applications. For example, the monitoring of tilt of an object gives important information relating to the stability or other conditions of the object. However, measuring or monitoring of tilt is not always easy due to, for example, difficulty in accessing an object, limited space for installing sensors in the proximity of the object, and other known difficulties experienced by persons skilled in the art.

### OBJECT OF THE INVENTION

Accordingly, it is an object of this invention to provide a sensor for monitoring tilt, movement or displacement of an object. At a minimum, this invention aims at providing an optical sensor for tilt monitoring.

### SUMMARY OF THE INVENTION

Broadly speaking, the present invention has described an optoelectronic device comprising an optical source and an optical detector, the optical source being adapted for emitting an optical beam for subsequent reflection towards the optical detector, the optical detector being adapted for receiving the optical beam and comprises a plurality of discrete optical detection regions for converting an optical beam into electrical energy and the optical detection regions are arranged so that an electrical characteristic of the optical detector is dependent on the relative distribution of an incident optical beam on the plurality of optical detection regions.

According to a preferred embodiment of the present invention, there is provided an optoelectronic apparatus for measuring tilt of an object, the apparatus comprising an optical source for emitting a light beam towards the object and an optical detector for detecting light reflected from the object, the optical detector comprises a plurality of optical detection regions which are for converting light into electrical energy and being arranged so that electrical output from the optical detector varies with angular deviation between the emitted and the reflected light beams.

Preferably, the electrical characteristic comprises electrical output, and the electrical output of each of said plurality of optical detection region per unit area optical illumination is the same.

Preferably, the optical source is surrounded by the plurality of optical detection regions of the optical detector.

Preferably, the optical source is located at the center of the optical detection regions.

Preferably, the optical source comprises a light emitting surface, the surface area of the light emitting surface is smaller than the surface area of light emitting surface of an optical detection region of the optical detector.

Preferably, the optical beam emitted from the optical source is divergent from the optical source so that a footprint of the reflected light beam when incident on the optical detector after reflection exceeds the footprint of the optical source.

Preferably, the plurality of optical detection regions are arranged into two optical detection groups, and electrical outputs of the two optical detection groups are equal when a light beam is equally or symmetrically incident on the two optical detection groups.

Preferably, the two optical detection groups are arranged so that when the electrical output of an optical detection group is at its maximum, the electrical output of the other optical detection group is at its minimum and vice versa.

Preferably, the optical detection regions are divided into two optical detection groups, the two optical detection groups being arranged so that electrical outputs from the two optical detection groups are unequal except when the emitted light beam and the reflected light beam have a common beam axis.

Preferably, the two optical detection groups are arranged so that an angular deviation between the emitted and reflected beams give rises to a difference in electrical outputs between the two optical detection groups.

Preferably, the optical detection regions are arranged so that electrical outputs of the two optical detection groups are equal when a reflected beam is incident normally on the optical detection regions.

Preferably, the optical detector comprises four optical detection regions divided by a right-cross shaped partition, the optical source is located at the center of the right-cross.

Preferably, the optical detector is arranged so that electrical output from the optical detector increases with an increase in angular deviation between the emitted and the reflected light beams.

Preferably, the apparatus further comprising means for correlating electrical output of the optical detector to the angular deviation between emitted and reflected light beams.

Preferably, the apparatus further comprising means for correlating distance of an object to the electrical outputs.

Preferably, the optical detector comprises two groups of optical detection regions for converting light into electrical energy, the optical detection regions being arranged so that electrical outputs of the two optical detection regions are unequal except when the emitted and reflected light beams are at a predetermined angular deviation.

Preferably, the predetermined angular deviation is zero.

Preferably, electrical outputs of the optical detection regions are subject to differential or superimpositional processing so that a minima or maxima respectively for differential or superimpositional processing occur at the predetermined angular deviation.

Preferably, the optical source and the optical detector are formed on a common support structure.

### BRIEF DESCRIPTION OF THE DRAWINGS

Preferred embodiments of the present invention will be explained in further detail below by way of examples and with reference to the accompanying drawings, in which:

FIG. 1 is a schematic diagram illustrating an opt-electronic device of this invention in an application as a tilt sensor,

FIG. 2 shows a schematic layout of an optoelectronic device of this invention,

FIG. 3 is a chart illustrating the divergence of an optical beam emitted by an optical source of the optoelectronic device of this invention,

FIG. 4 is a schematic diagram illustrating the optoelectronic device of FIG. 2 under illumination of a reflected optical beam with the coverage of the optical beam equally distributed among four discrete optical detection regions,

FIG. 5 is a schematic diagram showing the foot print of a reflected optical beam when impinging on the optoelectronic device of FIG. 2 after undergoing reflection by an article at a tilting angle α,

FIG. 6 is a schematic diagram showing the optoelectronic device of FIG. 2 when illuminated by a reflected optical beam wherein the originating optical impinges on an object having a plane of reflection tilted at an angle α relative to the horizontal,

FIG. 7 is a schematic diagram showing the reflection of an optical beam emitted by the optoelectronic device of FIG. 6 after the object has moved through a displacement δh,

FIG. 8 is a table showing numerical examples relating to shifting of impingement of an incoming beam spot in the optical detector vis-à-vis the tilt angle (α) and the height and variation of height of the object, and

FIG. 9 is a chart showing the relative photo current output of a first group of optical detection regions comprising photo-diodes 1 and 3 and photo-diodes 2 and 4 versus tilt angle.

### DETAILED DESCRIPTION OF THE PREFERRED EMBODIMENTS

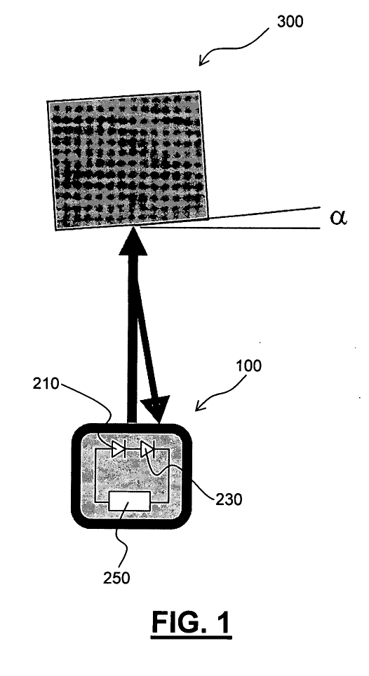

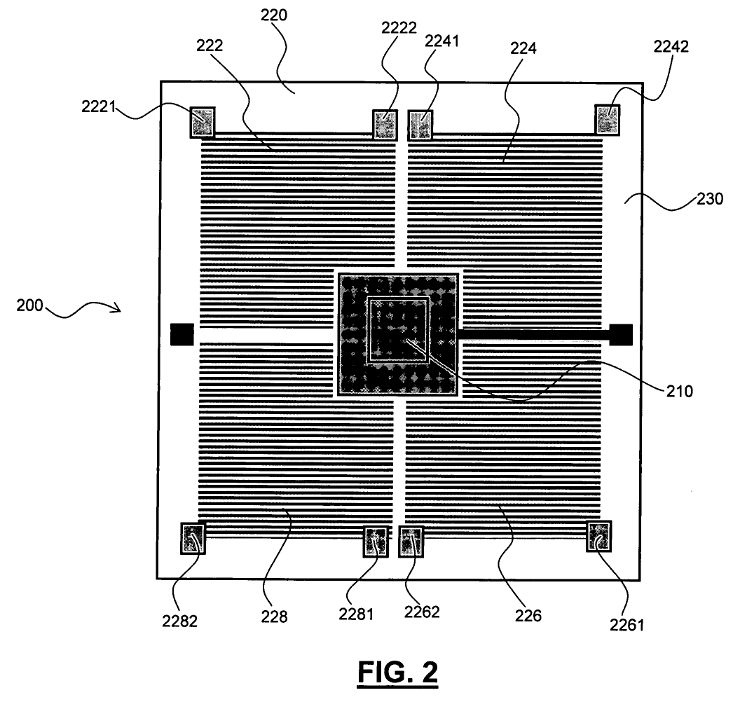

Referring to FIGS. 1 and 2, there is shown an optical sensor 100 comprising an optoelectronic device of FIG. 2 for measuring tilt of an object 300. The optoelectronic device 200 of FIG. 2 comprises an optical source 210 and an optical detector 220 which are mounted on a common supporting structure 230. The optical source 210 is adapted for emitting an optical beam towards an object for subsequent reflection back towards the optical detector 220. An example of a suitable source for this application is a VCSEL (Vertical Cavity Surface Emitting Laser) laser source. The optical detector 220 is adapted for receiving an optical beam originating from the laser source and comprises a plurality of discrete optical detection regions (222, 224, 226, 228). Each optical detection region is itself an optical detector responsive to and suitable for the detection of an optical signal of a wavelength emitted by the laser source. In addition to the optoelectronic device, the optical sensor further comprises difference circuitry and a controller 250 to control operation of the difference circuitry and to process information output of the different circuitry.

The optical detection regions are configured so that, for an incoming optical beam of even intensity, the electrical output of each of the optical detection region is dependent on the area of illumination. Therefore, the electrical output of each of the optical detection regions is identical when the area of illumination on each of the optical detection regions is the same.

The optical detector comprises four optical detection regions 222, 224, 226, 228 which are arranged at the four quadrants of a square with the optical source disposed at the centre of the square. The area of each of the optical sensitive optical detection regions is identical. The shape and configuration of an optical detection region is mirror symmetrical to the immediately adjacent optical detection region. Each optical detection region is provided with a pair of contacts (2221, 2222), (2241, 2242), (2261, 2262), (2281, 2282) for output to external circuitry, such as a difference circuitry, or other appropriate processing circuitry. The optical source and the optical detector are mounted together on a common supporting structure 230 such as a printed circuit board, a ceramic board or other appropriate substrates. The optical detection planes of the optical detectors are parallel and the optical source is aligned so that an optical beam emitted by the laser source is emitted along an axis which is substantially orthogonal to the plane of the optical detection regions. In this example, the optical detection regions are coplanar.

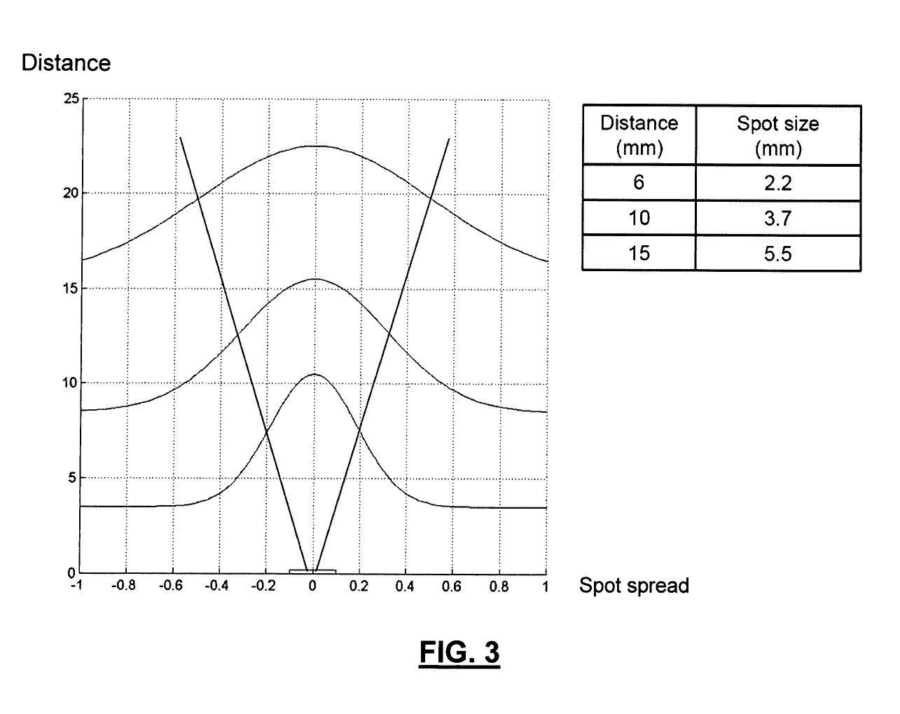

Electrical outputs of the individual optical detection regions are output to external circuitry via connection pads formed on the supporting structure. The exemplary optical source of this preferred embodiment has a divergent angle of 200 so that an optical beam emitted from the laser source is conical shaped with an angle of 20°. As can be seen from FIG. 3, the effective spot size increases as the optical beam moves away from the optical source. For example, at distances (L) of 6, 10 and 15 mm from the laser source (marked “0” on the X-axis in FIG. 3), the spot size, that is, the diameter (d) of the beam spot, is respectively 2.2, 3.7 and 5.5 mm according to the equation d=L tan(θ), where θ=20° in this example.

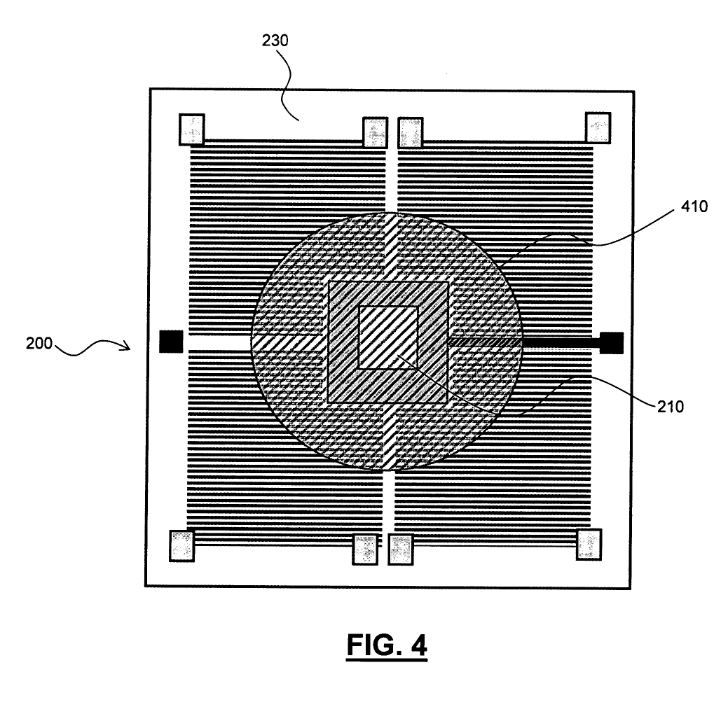

Referring to FIG. 4, the optoelectronic device 200 is illustrated with an incident beam which is impinging on the optical detector such that the area of illumination on each of the optical detection regions is identical. When the optoelectronic device is used in the manner as shown in the arrangement of FIG. 1, the central illumination of the beam spot 410 means that the incident (reflected) beam and the beam emitted by the laser source share a common axis so that the tilting angle α is nil. More particularly, each of the optical detection regions is configured so that the electrical output per unit illuminated area is the same. In the case of a nil tilt angle, the output of each of the optical detection is the same. Consequently, the difference in electrical outputs from the various discrete optical detection region is also nil. Hence, a nil difference output from the various optical detection regions could be interpreted as a zero tilting of the object. Of course, it would be appreciated that the angle of tilting is a relative parameter which depends on the position of the object relative to the beam orientations of the optoelectronic device. More specifically, the angle of tilting is a relative parameter of the axes of the emitted and reflected beams. For example, the controller 250 can be programmed so that the difference output is nil or is at a predetermined value when the object is at a predetermined tilting angle. The variation in the orientation of the beam axes of the reflected beam could be used to measure and interpret a relative tilting compared to an initial tilt.

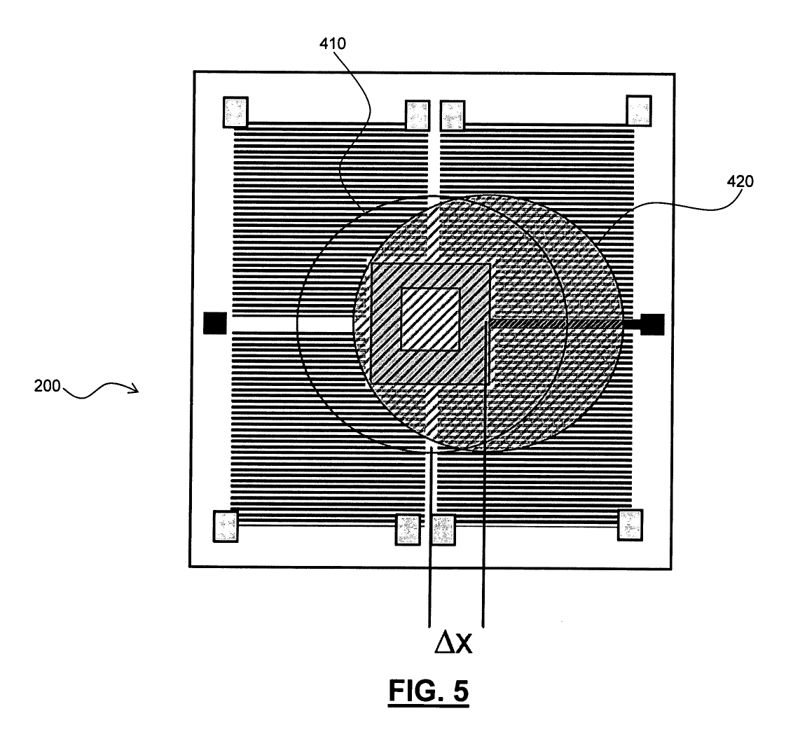

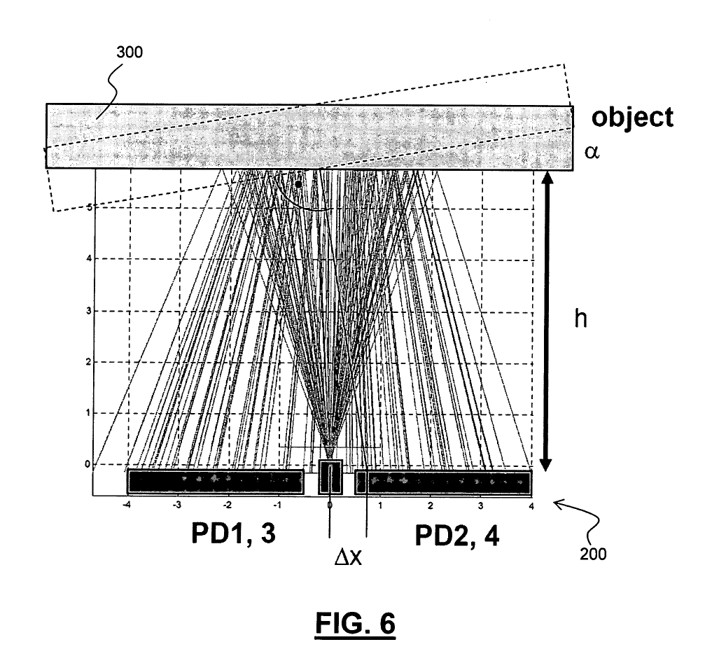

In FIGS. 5 and 6, the object is tilted from a zero tilting angle to a tilting angle α. As a result of the tilting of the object, the divergent beam originating from the laser source when reflected by the object and subsequently falls on the quad-photo detector will have a footprint of the diagonally hatched circular portion as shown in FIG. 5, as compared to the centrally impinging beam spot 410. The hatched beam spot 420 of FIG. 5 is displaced by a displacement δx so that the area of illumination on each of the individual quad-optical detection regions is not the same. Specifically, the illumination areas on optical detectors 1 and 3 (PD1 (222), PD3 (228)) are the same. The areas of illumination on optical detection regions 2 and 4 (PD2 (224, 226), PD4) are the same. However, the illumination areas on PD1 and PD2 are unequal. By monitoring the difference in electrical outputs between the first group of optical detection region comprising PD1 and PD3 and the second group of optical detection region comprising PD2 and PD4, the extent of tilting, as reflected by movement of the reflected beam spot along direction of X-axis, can be monitored by measuring the difference output.

Similarly, the tilting about another axis, which is orthogonal to the axis of tilting shown in FIGS. 5 and 6, can be monitored by measuring the difference in output of other groups of optical detection regions. For measuring tilting in that orthogonal direction, namely, the Y-axis, the difference output from another two groups of optical detection regions, namely, a first group comprising PD1 and PD2 and a second group comprising PD3 and PD4, can be monitored to measure the extent of tilting about the Y-axis. For the example of FIG. 6, as there is no tilting about the Y-axis, the difference output from the two optical detection groups (PD1, PD2) and (PD3, PD4) will be nil. By connecting the connection pads alternatively to form different grouping of the optical detection regions, the tilting in both the X and Y directions can be measured. Of course, the different groupings can be effected by switching, for example, electronic switching.

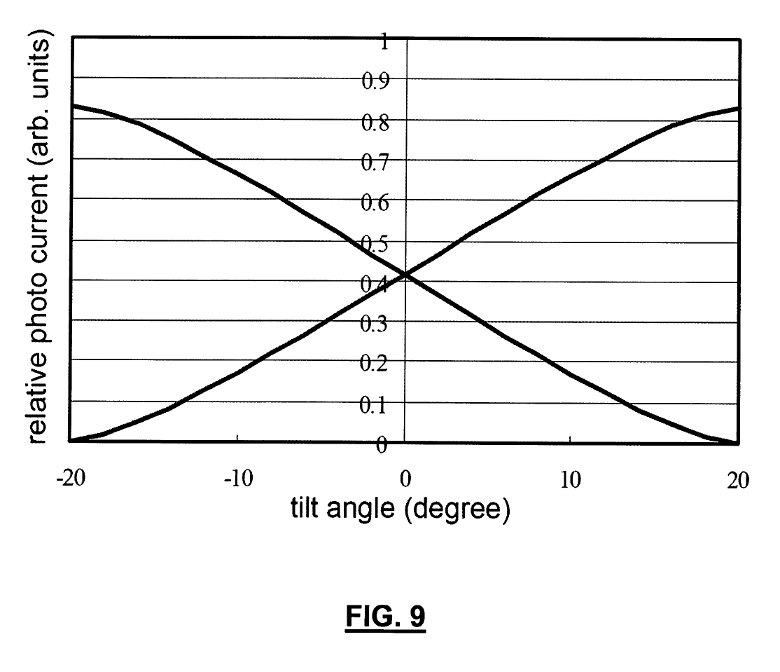

As shown in FIG. 9, the extent of tilting along the X-axis can be measured with reference to the electrical output chart which shows the relative photo-current output from the two groups of optical detection regions, namely, first group comprising PD1 and PD3 and a second group comprising PD2 and PD4. When the electrical current output of the first group is at its maximum, the electrical current output of the second group is at the minimum and vice versa. When the tilting angle is zero, that is, at the centre of the chart, the relative photo-current outputs of the two groups are the same and the difference output is nil. By following and/or utilizing the specific electrical output characteristics of the two groups of optical detection regions, the amount of actual relative tilting can be measured. To serve this purpose, a differential circuitry with appropriate calibration and/or amplification means (where appropriate) could be used to measure the actual difference with reference to the specific characteristics of the groups of optical detection regions. To provide a self-contained tilt sensor, the controller 250 is programmed to contain the output characteristics of the optical detection regions and to generate relevant information relating to the tilting of the object and to control operation of the difference circuitry.

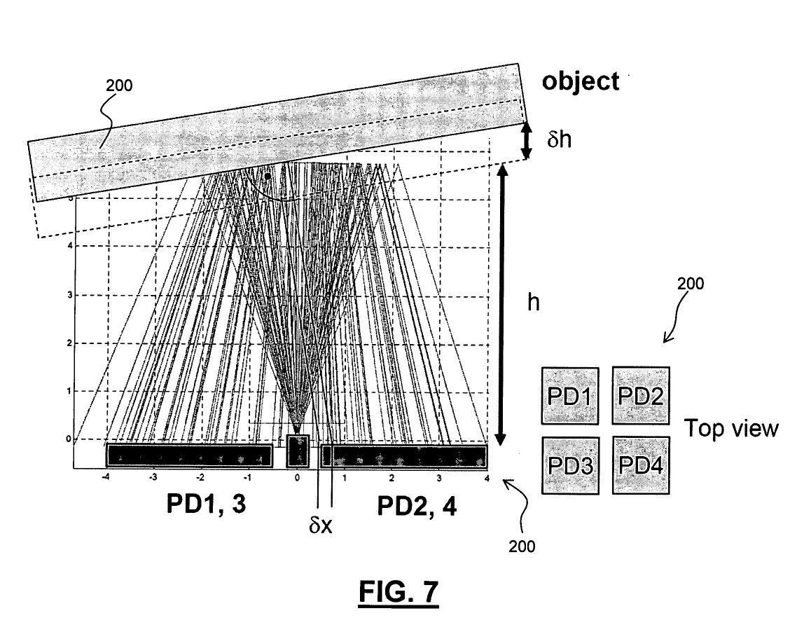

In addition to the measurement of tilting, the optoelectronic device can also be utilized to measure displacement of an object, as shown in FIG. 7. For example, when the tilted object has been displaced by a distance δh, the centre of the reflected beam spot will be moved by a displacement δx according to the equation δx=δh tan(α) and the spot diameter of the reflected beam spot changes according to the relationship δd=2δh tan(α).

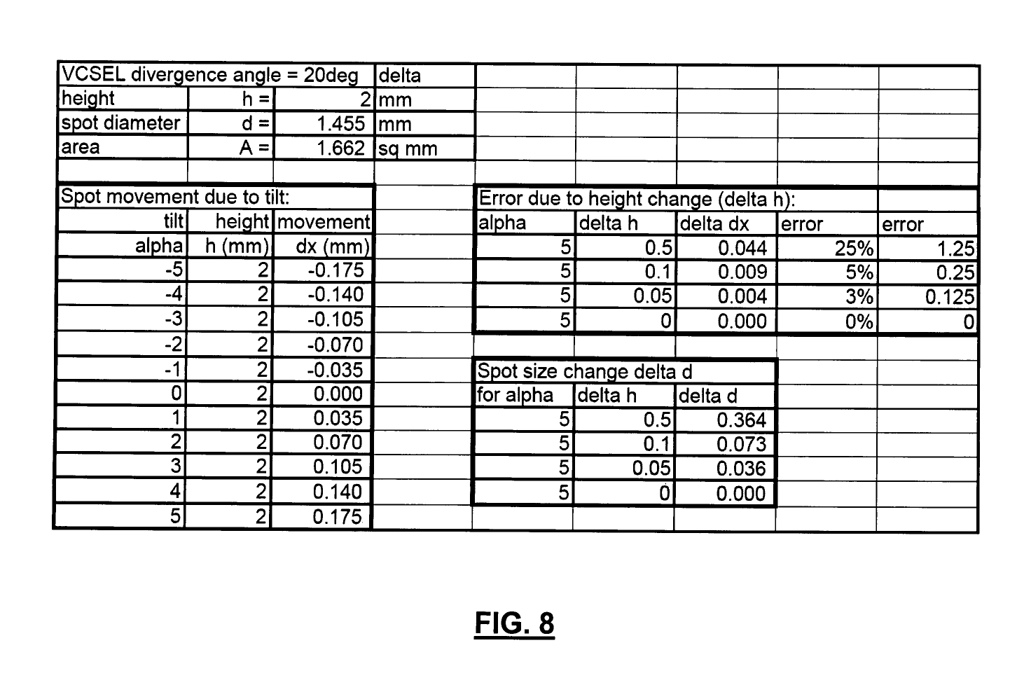

FIG. 8 is a table showing an exemplary relationship between the displacement (dx) of the beam spot from the nil position when an object is disposed at a height h of 2 mm above the optical source and various tilt angle α. As set out in the top rows of FIG. 8, the laser source has a divergence angle of 20° and the spot diameter of the reflected beam has a diameter of d=1.455 mm (area A=1.662 sq. mm). When the reflected beam and the emitted beam share a common axis, the angle of incidence of the optical beam is normal to the plane of the optical detection regions. The right side of the table of FIG. 8 shows the errors due to height change (δh). For example, at a tilting angle α of 5° and a δh of 0.5, the difference in displacement, δdx, is 0.044 and this error information can be used for error correction for measurements required higher precision.

While the present invention has been explained by reference to the examples or preferred embodiments described above, it will be appreciated that those are examples to assist understanding of the present invention and are not meant to be restrictive. Variations or modifications which are obvious or trivial to persons skilled in the art, as well as improvements made thereon, should be considered as equivalents of this invention.

Furthermore, while the present invention has been explained by reference to tilt monitoring, it should be appreciated that the invention can apply, whether with or without modification, to the monitoring of other spatial characteristics such as deformation, movements and/or displacements of an object without loss of generality.

1. An optoelectronic device comprising an optical source and an optical detector, the optical source being adapted for emitting an optical beam for subsequent reflection towards the optical detector, the optical detector being adapted for receiving the optical beam and comprises a plurality of discrete optical detection regions for converting an optical beam into electrical energy and the optical detection regions are arranged so that an electrical characteristic of the optical detector is dependent on the relative distribution of an incident optical beam on the plurality of optical detection regions.

2. An optoelectronic device according to claim 1, wherein the electrical characteristic comprises the electrical output, and wherein the electrical output of each of said plurality of optical detection region per unit area optical illumination is the same.

3. An optoelectronic device according to claim 1, wherein the optical source is surrounded by the plurality of optical detection regions of the optical detector.

4. An optoelectronic device according to claim 3, wherein the optical source is located at the center of the optical detection regions.

5. An optoelectronic device according to claim 1, wherein the optical source comprises a light emitting surface, the surface area of the light emitting surface is smaller than the surface area of light emitting surface of an optical detection region of the optical detector.

6. An optoelectronic device according to claim 1, wherein the optical beam emitted from the optical source is divergent from the optical source so that a footprint of the reflected light beam when incident on the optical detector after reflection exceeds the footprint of the optical source.

7. An optoelectronic device according to claim 1, wherein the plurality of optical detection regions are arranged into two optical detection groups, and wherein electrical outputs of the two optical detection groups are equal when a light beam is equally or symmetrically incident on the two optical detection groups.

8. An optoelectronic device according to claim 7, wherein the two optical detection groups are arranged so that when the electrical output of an optical detection group is at its maximum, the electrical output of the other optical detection group is at its minimum and vice versa.

9. An optoelectronic device according to claim 1, wherein the optical detection regions are divided into two optical detection groups, the two optical detection groups being arranged so that electrical outputs from the two optical detection groups are unequal except when the emitted light beam and the reflected light beam have a common beam axis.

10. An optoelectronic device according to claim 9, wherein the two optical detection groups are arranged so that an angular deviation between the emitted and reflected beams give rise to a difference in electrical outputs between the two optical detection groups.

11. An optoelectronic device according to claim 9, wherein the optical detection regions are arranged so that electrical outputs of the two optical detection groups are equal when a reflected beam is incident normally on the optical detection regions.

12. An optoelectronic device according to claim 1, wherein the optical detector comprises four optical detection regions divided by a right-cross shaped partition, the optical source is located at the center of the right-cross.

13. An optoelectronic apparatus for measuring tilt of an object, the apparatus comprising an optical source for emitting a light beam towards the object and an optical detector for detecting light reflected from the object, the optical detector comprises a plurality of optical detection regions for converting light into electrical energy and being arranged so that electrical output from the optical detector varies with angular deviation between the emitted and the reflected light beams.

14. An optoelectronic apparatus according to claim 13, wherein the optical detector is arranged so that electrical output from the optical detector increases with an increase in angular deviation between the emitted and the reflected light beams.

15. An optoelectronic apparatus according to claim 13, further comprising means for correlating electrical output of the optical detector to the angular deviation between emitted and reflected light beams.

16. An optoelectronic apparatus according to claim 15, further comprising means for correlating distance of an object to the electrical outputs.

17. An optoelectronic apparatus according to claim 13, wherein the optical detector comprises two groups of optical detection regions for converting light into electrical energy, the optical detection regions being arranged so that electrical outputs of the two optical detection regions are unequal except when the emitted and reflected light beams are at a predetermined angular deviation.

18. An optoelectronic apparatus according to claim 17, wherein the predetermined angular deviation is zero.

19. An optoelectronic apparatus according to claim 17, wherein electrical outputs of the optical detection regions are subject to differential or superimpositional processing so that a minima or maxima respectively for differential or superimpositional processing occur at the predetermined angular deviation.

20. An optoelectronic apparatus according to claim 19, wherein the optical source and the optical detector are formed on a common support structure.
